(19) United States
(12) Patent Application Publication
(10) Pub. No.: US 2009/0067908 A1
(43) Pub. Date: Mar. 12, 2009

(54) IMAGE FORMING APPARATUS

(75) Inventors: Masataka MURATANI, Akishima-shi (JP); Kazumasa Yasui, Tokyo (JP); Kenichiro Shishikura, Numazu-shi (JP); Shinya Sugimoto, Mishima-shi (JP)

Correspondence Address: PATTERSON & SHERIDAN, L.L.P., 3040 POST OAK BOULEVARD, SUITE 1500, HOUSTON, TX, 77056, US

(73) Assignees: Kabushiki Kaisha Toshiba, Tokyo (JP); Toshiba Tec Kbushiki Kaisha, Tokyo (JP)

(21) Appl. No.: 12/207,439

(22) Filed: Sep. 9, 2008

Related U.S. Application Data
(60) Provisional application No. 60/971,253, filed on Sep. 10, 2007.
(60) Provisional application No. 60/972,228, filed on Sep. 13, 2007.
(60) Provisional application No. 60/972,230, filed on Sep. 13, 2007.
(60) Provisional application No. 60/972,738, filed on Sep. 14, 2007.

(51) Int. Cl. G03G 15/00

(52) U.S. Cl. 399/401

(57) ABSTRACT

According to an aspect of the invention, an image forming apparatus includes, an image forming section which forms an image on a sheet-like recording medium, a conveying path through which the recording medium passes, a conveying section which conveys the recording medium along the path in a conveying direction and has a reverse conveying portion which reversely conveys the recording medium in a direction opposite to the conveying direction, a main body, a first medium holding section which is disposed on the main body to hold the recording medium discharged from a first discharge port, a second medium holding section which holds the recording medium discharged from a second discharge port disposed above the first discharge port of the main body, and a third medium holding section which is disposed below the second medium holding section to hold the recording medium reversely conveyed by the conveying section.

### CROSS-REFERENCE TO RELATED APPLICATIONS

This application claims the benefit of U.S. Provisional Applications No. 60/971,253, filed Sep. 10, 2007; No. 60/972,228, filed Sep. 13, 2007; No. 60/972,230, filed Sep. 13, 2007; and No. 60/972,738, filed Sep. 14, 2007.

### TECHNICAL FIELD

The present invention relates to an image forming apparatus having a reversing unit (reversing section).

### BACKGROUND

An image forming apparatus having a reversing section such as a switchback type ADU (automatic duplex unit) for reversing a sheet has been known. In the reversing section, a sheet conveyed from an image forming section is switched back by using a reversing roller, and is reversed by passing through a circulating section, and is reconveyed to the image forming section.

Generally, as a space for switching back a reverse sheet, a space for sheet discharge in the body of the apparatus or a space such as a side of the apparatus was used. In an apparatus layout configured so that the sheet discharge space is provided in the body, the space in the body is divided into an upper side and a lower side. Generally, in most of image forming apparatuses, the lower side area is used as an area for sheet discharge, and the upper side area is used as a reversal switchback area.

Furthermore, an apparatus having a sheet discharge port formed on the upper part of the side thereof employs a layout in which a lower side space in front of the sheet discharge port is used as a reversal space.

However, in the known reversal space layout, there is a problem that it is hard to secure the reversal space for a comparatively long sheet.

Accordingly, to secure the reversal space for the long sheet, it is unavoidable that the reversal space should be curved in the layout.

### SUMMARY

According to an aspect of the invention, an image forming apparatus comprises, an image forming section which forms an image on a sheet-like recording medium, a conveying path through which the recording medium passes, a conveying section which conveys the recording medium along the conveying path in a conveying direction and has a reverse conveying portion for reversely conveying the recording medium in a direction opposite to the conveying direction on the conveying path, a main body which houses the image forming section, a first medium holding section which is disposed on the main body to hold the recording medium discharged from a first discharge port, a second medium holding section which holds the recording medium discharged from a second discharge port disposed above the first discharge port of the main body, and a third medium holding section which is disposed below the second medium holding section to hold the recording medium reversely conveyed by the conveying section.

According to another aspect of the invention, a reversing unit constituting the conveying path has an intermediate guide disposed on a lower side of the second conveying path and on an upper side of the second conveying path, an upper guide disposed above the second conveying path to open the second conveying path by pivoting upward with respect to the intermediate guide about a supporting point on one side in a width direction orthogonal to the conveying direction, and a lower guide disposed on a lower side of the first conveying path to open the first conveying path by pivoting downward with respect to the intermediate guide about the supporting point on the one side.

According to another aspect of the invention, a method for forming an image comprises, outputting an image on a sheet-like recording medium conveying the recording medium having the image formed thereon along a predetermined conveying path having a first conveying path which reaches the first discharge port from the image forming section, a second conveying path which reaches the second discharge port disposed above the first discharge port by branching upward from a first branch portion disposed on the first conveying path and has a reverse conveying portion reversely conveying the recording medium in the course thereof, a third conveying path which branches downward from a second branch portion disposed on the second conveying path, and a fourth conveying path which reaches the image forming section from the reverse conveying portion; and withdrawing the recording medium to be reversely conveyed by the reverse conveying portion into the third conveying path after conveying the recording medium to the second conveying path.

Objects and advantages of the invention will become apparent from the description which follows, or may be learned by practice of the invention.

### DESCRIPTION OF THE DRAWINGS

The accompanying drawings illustrate embodiments of the invention, and together with the general description given above and the detailed description given below, serve to explain the principles of the invention.

FIG. 1 is a schematic view for explaining an image forming apparatus according to a first embodiment of the invention.

FIG. 2 is a schematic view for explaining a reversing unit in the image forming apparatus.

FIG. 3 is an explanatory view illustrating a reversing section in the image forming apparatus.

FIG. 4 is an explanatory view illustrating an operation of the reversing section in the image forming apparatus.

FIG. 5 is an explanatory view illustrating an operation of the reversing section in the image forming apparatus.

FIG. 6 is an explanatory view illustrating an operation of the reversing section in the image forming apparatus.

FIG. 7 is a perspective view illustrating a reversing unit of an image forming apparatus according to a second embodiment.

FIG. 8 is an enlarged perspective view illustrating a part of the reversing unit.

FIG. 9 is a perspective view illustrating an open state of a lower side conveying path of the reversing unit.

FIG. 10 is a perspective view illustrating an open state of the lower side conveying path of the reversing unit.

FIG. 11 is a perspective view illustrating an operation portion of the reversing unit.

FIG. 12 is a schematic view for explaining a part of a reversing unit according to a third embodiment.

FIG. 13 is a perspective view illustrating a lower guide and a rear plate of the reversing unit according to the third embodiment.

FIG. 14 is an enlarged perspective view illustrating a part of FIG. 13.

FIG. 15 is a side view illustrating the lower guide and the rear plate of the reversing unit according to the third embodiment.

FIG. 16 is a perspective view illustrating an operation portion of a reversing unit according to another embodiment.

FIG. 17 is a perspective view illustrating an operation portion of a reversing unit according to another embodiment.

FIG. 18 is a perspective view illustrating an operation portion of a reversing unit according to another embodiment.

FIG. 19 is a perspective view illustrating an operation portion of a reversing unit according to another embodiment.

### DETAILED DESCRIPTION

### First Embodiment

Hereinafter, an image forming apparatus 1 according to embodiments will be described. In each drawing, each configuration is appropriately enlarged, reduced, or omitted for explanatory convenience. In addition, X, Y and Z represent three directions orthogonal to each other.

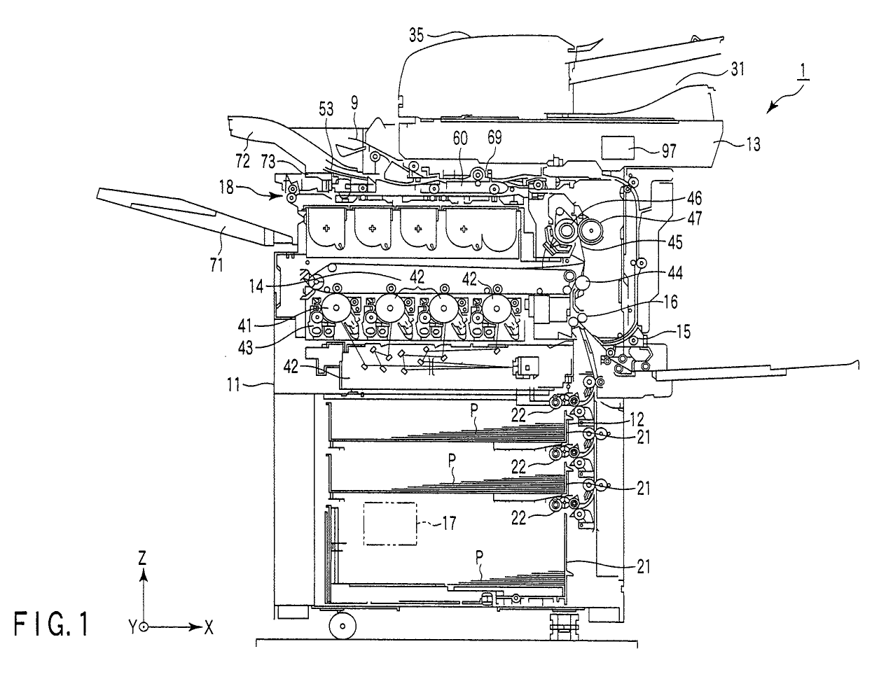

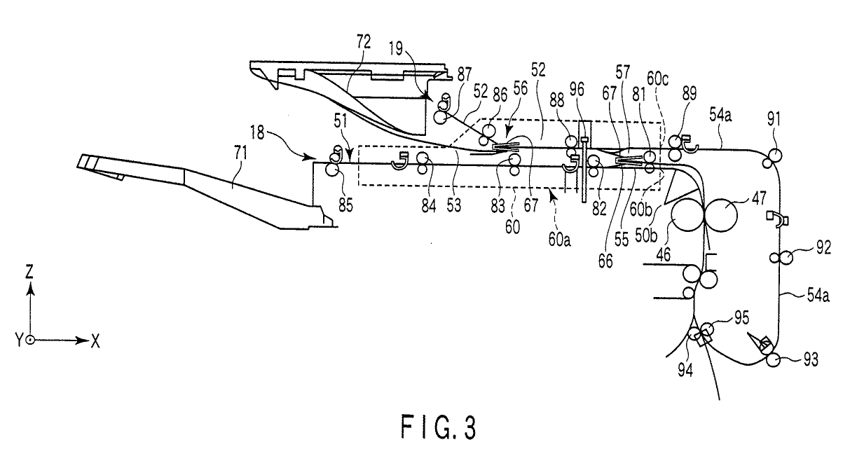

FIG. 1 is a schematic view for explaining an image forming apparatus 1 according to a first embodiment of the invention. The image forming apparatus 1 includes a main body 11 constituting an exterior of the image forming apparatus 1, and a sheet feeding section 12 for feeding sheets P (output media) to a sheet conveying path 15 which is able to hold sheets P and is formed along a predetermined route. Also provided are an image reading section 13 (scanner section) for reading image data of a target image, and an image forming section 14 for forming an image on the sheet P. Also provided are a sheet conveying section 16 having rollers 81 to 95 (shown in FIG. 3) and guide members 61 to 65 (shown in FIG. 3) arranged along the sheet conveying path 15 to convey sheets P, and a control section 17 for controlling operations of the respective sections 12 to 16. On an exterior part of the main body, there are provided a first discharge port 18 for discharging sheets and a second discharge port 19 for discharging sheets. The second discharge port 19 is disposed above the first discharge port 18.

The main body 11 houses the image forming section 14 and the conveying section 16, and the conveying path 15 is formed therein.

The sheet feeding section 12 includes sheet cassettes 21 capable of holding sheets P and feeding the sheets P one by one, and a pickup roller 22 for optionally extracting the sheets P from the sheet cassettes 21 in accordance with image formation not described herein in detail. The sheet feeding section 12 feeds to the image forming section 14 sheets P having an optional size used in image output.

The image reading section 13 reads out image data of a target image in the image forming section 14 from the target object (hereinafter, it is referred to as an original document) having image information. The image reading section 13 is provided with an automatic document feeder 32 (ADF) for discharging the read original document to a discharging position 31 and guiding another target original document to a reading position.

The image forming section 14 forms on a sheet P an image corresponding to image data input to the conveyed sheet P by instruction and the image data read out in the image reading section 13 as an output image such as a hard copy or a print out.

The image forming section 14 includes a photoconductive drum 41 for holding a latent image, an exposure unit 42 for forming a latent image on the photoconductive drum 41. Also provided are a development unit 43 for developing a latent image formed on the photoconductive drum 41, a transfer unit 44 for transferring the toner image developed by the photoconductive drum 41 into a sheet P having an optional size as a recording medium, and a fixing unit 45 for fixing the toner image on the sheet P on which the toner image is transferred by the transfer unit 44. The fixing unit 45 has a fixing roller 46 and a press roller 47. The fixing roller 46 and the press roller 47 send a sheet P to a reversing unit 60a at a predetermined speed. Specifically, the fixing roller 46 and the press roller 47 also function as the sheet conveying section 16.

As shown in FIGS. 1 to 3, the sheet conveying path 15 reaches upward to the image forming section 14 from a plurality of sheet cassettes 21 in the lower side area of the image forming apparatus 1. The sheet conveying path 15 includes first to fourth conveying paths 51 to 54 formed on a reversing section 60 of the upper side area of the image forming apparatus 1.

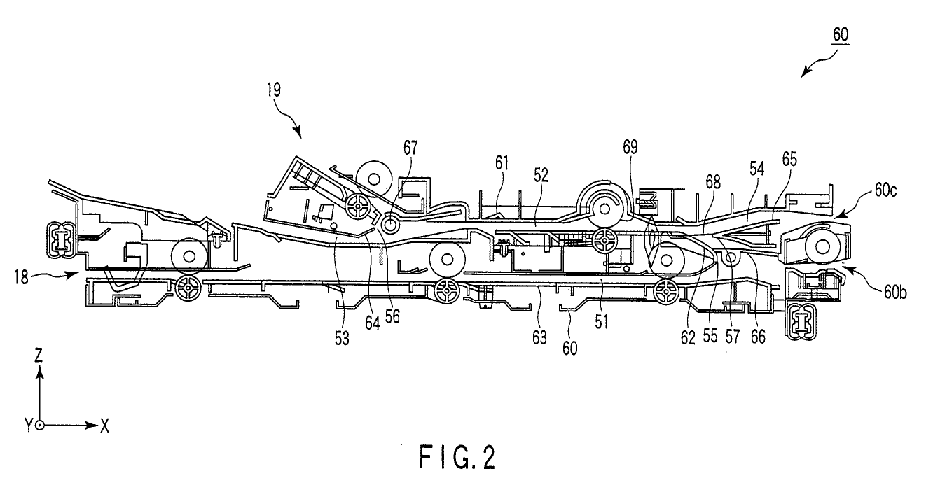

As shown in FIGS. 2 and 3, the first conveying path 51 reaches leftward to the first discharge port 18 from the downstream side of the image forming section 14. A unit entrance 60b is disposed on the first conveying path 51.

The second conveying path 52 branches upward from a first branch portion 55 disposed on the first conveying path 51, and reaches leftward to the second discharge port 19. The second conveying path 52 has a reverse conveying portion 69 for reversely conveying sheets on the path.

The third conveying path 53 is formed by branching downward to the outside of the main body 11 from a second branch portion 56 disposed on the second conveying path 52. Furthermore, a distance from the first branch portion 55 to a leading end of the third conveying path 53 through the second conveying path 52 and the second branch portion 56 is set larger than a length of a sheet P subjected to the processes in the conveying direction. Accordingly, when the sheet P to be reversed is being withdrawn to the third conveying path 53, it is possible to convey another sheet through the first conveying path 51 of the lower side.

A circulation path 54a constituting the fourth conveying path 54 branches upward to the right side from the third branch portion 57 disposed on the right side from the reverse conveying portion 69 of the second conveying path 52. Then, the path passes a unit exit, and is curved downward to the right side additionally. Finally, the path reaches to the image forming section 14.

A reversing section 60 for reversing a sheet P is a part of the sheet conveying section 16. The reversing section 60 is provided on the left of the fixing section 45 (fixing unit) of the image forming section 14 in the upper side area of the image forming apparatus 1.

The reversing section 60 shown in FIGS. 2 and 3 is, for example, a stackless type ADU (automatic duplex unit) in a switchback manner using a reversing roller 88. The reversing section takes charge of the reversing and conveying. The reversing section 60 has the unit entrance 60b for receiving the recording medium (sheet P) discharged from the fixer (fixing section 45). When an image is formed on one side of the sheet P and the fixing process is terminated, the recording medium (sheet P) is conveyed leftward from the fixing section 45, and is conveyed to the reversing section 60.

FIG. 2 is a schematic view for explaining the reversing section 60. In FIGS. 2 and 3, there are shown a roller member, a guide (guide member), and a conveying path switch gate necessary for sheet conveying operations such as fixation, reversal, circulation, and sheet discharge.

The reversing section 60 includes the first to fifth guide members 61 to 65 constituting the first to fourth conveying paths 51 to 54, and a first gate 66, a second gate 67, and a third gate 68 disposed on the first to third branch portions 55 to 57, respectively, so as to open and close the conveying path 15. Also provided are a plurality of conveying rollers (roller members) arranged along the conveying path 15 to convey sheets, and a reverse conveying portion 69 disposed on the second conveying path 52 to reversely convey the sheet in a direction opposite to the conveying direction.

A first tray 71 is disposed on the first sheet discharge port 18. The first tray 71 is disposed outside the main body 11, and holds sheets P on the upper surface thereof from the first sheet discharge port 18.

A second tray 72 is disposed on the second sheet discharge port 19. The second tray 72 is disposed outside the main body 11 and above the first tray 71, and holds sheets P on the upper surface thereof from the second sheet discharge port 19.

Furthermore, the first sheet discharge port 18 is disposed outside of the second sheet discharge port 19 on the outside of the main body 11. The first tray 71 is disposed outside of the second tray 72. Specifically, the first sheet discharge port 18 and the second sheet discharge port 19 are apart from each other in vertical and horizontal directions. The first tray 71 and the second tray 72 are also apart from each other in vertical and horizontal directions.

A third tray 73 is disposed below the second tray 72. The third tray 73 holds the sheet to be reversely conveyed from the reverse conveying portion 69. The third conveying path 53 is formed between the rear side of the second tray 72 and the upper side of the third tray 73. An outer (the left side in FIG. 1) leading end of the second tray 72 is disposed outside of an outer leading end of the third tray 73.

The first guide 61 (upper guide 61) is disposed on the top of the reversing section 60, and constitutes the second conveying path 52.

The second guide 62 (intermediate guide 62) is disposed on the center of the reversing section 60, and divides the first conveying path 51 and the second conveying path 52. The right side end portion of the second guide 62 constitutes the first branch portion 55. The first branch portion 55 is formed in the vicinity of the unit entrance 60b of the sheet conveying path 15.

The third guide 63 (lower guide 63) is disposed below the second guide 62, and constitutes the first conveying path 51.

The fourth guide 64 is disposed on the left side of the reversing section 60 and divides the second conveying path 52 and the third conveying path 53. The right side end portion of the fourth guide 64 constitutes the second branch portion 56.

The fifth guide 65 is disposed on the right side of the reversing section 60 and divides the second conveying path 52 and the fourth conveying path 54. The left side end portion of the fifth guide 65 constitutes the third branch portion 57.

The first switch gate 66 is disposed on the first branch portion 55 in the vicinity of the unit entrance 60b. The first switch gate 66 has a switch function of selectively guiding a sheet P to any one of the first conveying path 51 and second conveying path 52 from the first branch portion 55. The first switch gate 66 is controlled to pivot such that the leading end portion on the right side in the drawing moves up and down. Thereby, one of the first conveying path 51 and the second conveying path 52 on the downstream side is opened and the other one is closed. As a result, a sheet P is guided to the opened conveying path.

The two sheet conveying paths 51 and 52 are formed to extend from the first branch portion 55 substantially in the horizontal direction. The first conveying path 51 on the lower side extends to the first sheet discharge port 18 for discharging a sheet substantially toward the side of the apparatus. The second conveying path 52 on the upper side extends to the second sheet discharge port 19 substantially directed to the side or an obliquely upward direction of the apparatus. The first tray 71 is disposed on the first sheet discharge port 18, and the second tray 72 is disposed on the second sheet discharge port 19.

A second switch gate 67 has a switch function of selectively guiding a sheet P to any one of the second conveying path 52 and third conveying path 53 from the second branch portion 56. The second switch gate 67 is controlled to pivot such that the leading end portion moves up and down. Thereby, one of the second conveying path 52 and the third conveying path 53 on the downstream side of the second branch portion 56 is opened and the other one is closed. As a result, a sheet P is guided to the opened conveying path.

The second branch portion (branch portion) 56 is formed on the upper side second conveying path 52. The second gate 67 for selectively opening and closing the second branch portion 56 is disposed on the second branch portion 56. Two upward and downward conveying paths are formed on the left side of the second branch portion 56.

A reverse conveying roller 88 (reversing roller 88) constituting the reverse conveying portion 69 is disposed on the central portion of the second guide 62. The reversing roller 88 switches back the sheet P to the upstream side from the downstream side by rotating in accordance with control of the control section. A reversal sensor 96 is disposed in front of (the right side of the drawing) the reversing roller 88 for reversely conveying the sheet P. The sheet P to be reversed is temporally stopped in a position where the sheet does not depart from the reversing roller 88, that is, in the vicinity of a position where the trailing end of the sheet reaches to the reversal sensor 96, and a reverse operation is performed thereon.

A third switch gate 68 (reverse film 68) has a guide function for surely sending the reversed sheet P reversely conveyed to the circulating path. The reverse film 68 as the third gate member is disposed close to the second conveying path 52. In the reverse film 68, the leading end portion thereof on the downstream side is formed in a flexible valve shape, and the base end portion thereof on the upstream side is fixed on the conveying path. When the sheet P is conveyed from the upstream (unit entrance 60b) to the downstream (second conveying path 52), the leading end portion of the film is moved upward to form an interspace enabling the conveying of the sheet P. When the sheet P is conveyed from the downstream side (second conveying path 52) to the upstream side (fourth conveying path 54), the film guides the sheet P upward to a unit exit 60c along the fourth conveying path 54 by blocking the first conveying path 51.

Sheet conveying rollers 81 to 95 are arranged along the sheet conveying path 15 in the sheet conveying section 16.

In the interest of a process time for continuous sheets P, the sheet conveying roller 81 in front of the gate has a function of accelerating the sheets P processed by a fixing process to send the sheets P to the next process.

The sheet conveying rollers 82 to 85 are configured to convey the sheets to the first sheet discharge port 18. The rollers are controlled generally at various speeds similarly to the roller 81 in front of the first gate 66. The sheet conveying rollers 86 and 87 are configured to convey the sheets to the second sheet discharge port 19. The rollers are controlled generally at various speeds similarly.

The reverse conveying roller 88 (reversing roller 88) constituting the reverse conveying portion 69 is disposed on the central portion of the second guide 62. The reversing roller 88 switches back the sheet P from the downstream side to the upstream side by rotating normally or reversely in accordance with control of the control section.

The sheet conveying roller 89 is configured to convey the sheets P to the circulating path 54a. The sheet conveying rollers 91, 92, and 93 are configured to convey the sheets P in the circulating path 54a. The sheet P conveyed in the circulating path 54a is refed by registration rollers 94 and 95, and an image formation is performed on a second recording side of the sheet P.

In the image forming apparatus 1, the instruction input section 97 is disposed. The instruction input section 97 (shown in FIG. 1) is configured to instruct the image forming section 14 to start forming an image or instruct the image reading section 13 to start reading image data of an original document. The instruction input section 97 includes, for example, a host computer PC and a control panel (operation portion) disposed on the front end portion of the image reading section 13.

For example, a user can request the image forming apparatus 1 to print out by operating the host computer PC. In this case, image light (exposure light) corresponding to image data to be output is emitted from the exposure unit 42 to the photoconductive drum 41. In this manner, an electrostatic latent image corresponding to the exposure light emitted from the exposure unit 42 is formed on the photoconductive drum 41. The electrostatic latent image formed on the photoconductive drum 41 is developed by toner contained in the development unit 43 to be visualized. One toner image formed on the photoconductive drum 41, that is, one output image is obtained from any one of sheet cassettes 21 by the sheet feeding roller and a separation roller. In addition, the one image is transferred by the transfer unit 44 on a sheet-like medium, that is, the sheet P conveyed through the conveying path 15.

The toner image (output image) transferred on the sheet P is fixed on the sheet P by the fixing unit 45.

On the other hand, in the above-mentioned image forming apparatus 1, a user can instruct the image reading section 13 (ADF 32) to read image data and form an image, that is, copy from the sheet-like medium which is an original document. In this case, the image data of the original document is recorded as brightness and darkness of light by the image reading section 13.

Subsequently, in the above-mentioned process similar to a printing, the toner corresponding to the image data of the original document is formed. Thus, the toner image is transferred and fixed on the sheet P conveyed through the conveying path 15 at a predetermined time.

A single sided image formation is finished by fixing the toner image transferred in the fixing unit 45. The sheet P is conveyed to the reversing section 60 from an entry path (unit entrance) 60b of the sheet P. At the branch portion (first branch portion 55), the sheet P is send to processing sections after the fixing process by selecting any one of the conveying path 51 on the lower side and the conveying path 52 on the upper side in accordance with a position of the first gate 66. Then, the next process is performed on the sheet P. Hereinafter, first to third processes in the reversing section will be described.

### First Process (Reversing)

A first process is a process for conveying a sheet P to the circulating path after the switchback operation for recording an image on the second recording surface (the rear side). The third conveying path 53 functioning as a withdrawing path for the switchback operation extends toward just the lower side of the tray 72 disposed on the second sheet discharge port 19. The path as a withdrawing path 53 is formed below the tray member 72 when the reversed sheet P is switched back.

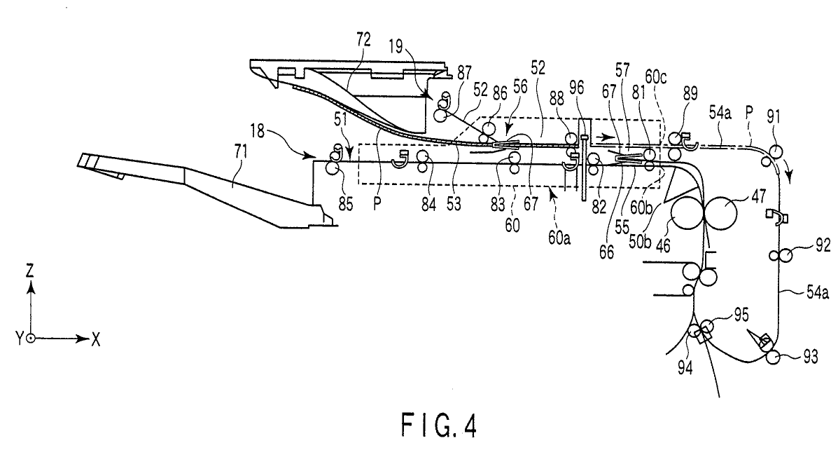

As shown in FIGS. 2 and 4, when the reversing is performed, the second conveying path 52 on the upper side is selected in the first gate 66, and the sheet P is conveyed to the upper side conveying path (second conveying path 52). Subsequently, the leading end of the sheet P reaches to the second gate 67. By the operation of the second gate 67, the leading end of the sheet P is able to be guided to the third conveying path 53 under the second tray 72.

Furthermore, a distance from the first branch portion 55 to a leading end of the third conveying path 53 through the second conveying path 52 and the second branch portion 56 is set larger than a length of a sheet P subjected to the processes in the conveying direction. Thus, as shown in FIG. 4, when the sheet P to be reversed by the reversing roller 88 is being withdrawn to the third conveying path 53, it is possible to convey another sheet through the first conveying path 51 of the lower side.

The numeral 53 in the drawing denotes the third conveying path 53 functioning as the withdrawing path. When the trailing end portion of the sheet P just passes through the first gate 66 and the reverse film 68, the sheet P is temporarily stopped. Then, the reversing roller 88 is reversely rotated. At this time, the sheet P is started to be conveyed in the right direction in FIG. 2, and is sent toward the unit exit 60c which is an entry for entering to the circulating path (circular conveying path) 54a.

The reverse conveying roller 88 conveys the sheet P which is in the range from the second conveying path 52 to the third conveying path 53 on the lower side of the second branch portion 56, in the reverse direction, that is, the right direction in the drawing. At this time, the reverse film 68 closes the lower side first conveying path 51 at the third branch portion 57. Thus, the sheet is prevented to return to the first conveying path 51 on the lower side, and the sheet P is guided from the third branch portion 57 to the fourth conveying path 54 on the upper right side. Furthermore, the sheet P is reversed while passing through the circulation path 54a by rotating the conveying roller, and is reconveyed to the image forming section 14.

The sheet P conveyed in the circulating path 54a is refed by the registration rollers 94 and 95, and image formation is performed on the second recording surface. After the image formation on the second recording surface, the sheet P is discharged by the following second process or third process.

### Second Process (Process of Sheet Discharge to Second Tray 72)

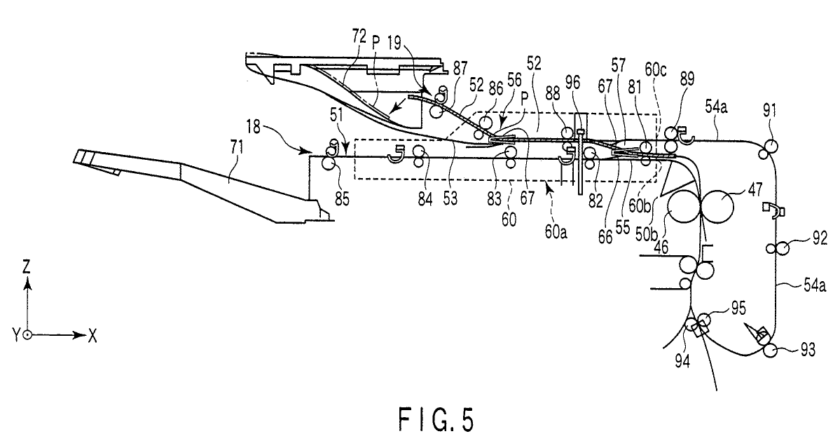

The second process shown in FIGS. 2 and 5 is a process of discharging a sheet to the second sheet discharge port 19. In the case of the process of discharging a sheet P to the second tray 72, the sheet P is conveyed through the upper side second conveying path 52 selected at the first gate 66 and the upper side conveying path selected at the second gate 67 to the second sheet discharge port 19. Then, the sheet P is discharged to the second tray 72 through the second sheet discharge port 19. The discharged sheets P are sequentially accumulated on the second tray 72 and are held by the tray.

### Third Process (Process of Sheet Discharge to First Tray 71)

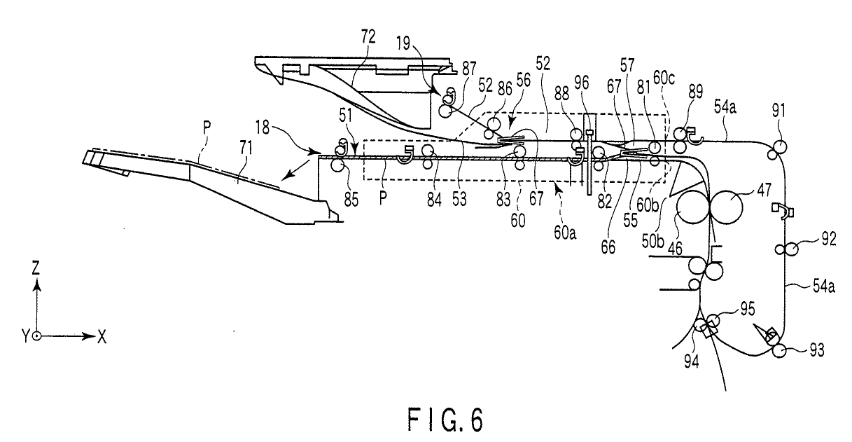

As shown in FIGS. 2 and 6, in the case of the third process of discharging a sheet P to the first tray 71, the sheet P is conveyed through the lower side first conveying path 51 selected at the first gate 66 to the first sheet discharge port 18. Then, the sheet P is discharged leftward from the first sheet discharge port 18 to the first tray 71. The discharged sheets P are sequentially accumulated on the first tray 71 and are held by the tray.

The image forming apparatus 1 according to the embodiment is able to obtain the following advantages. Specifically, with such a configuration, an image recording unit simply configured to have a second sheet discharge tray and an image recording apparatus simply configured to have a withdrawing path of a relatively long reversed sheet P are combined. As a result of the combination, it is possible to design a reasonable layout of a reversing path of the image forming apparatus 1.

The third conveying path 53 which is a withdrawing path of the reversed sheet P is reasonably disposed below the second tray 72. A user can stably acquire discharged sheets P accumulated on the second tray 72 even when the reversing of long sheets P is performed.

As a comparative example, the case without using the second gate 67 will be described additionally. When the second gate 67 is removed from the above-mentioned embodiment, that is, when the second sheet discharge port 19 is intactly used as a withdrawing path of the reversed sheet P, the following problem is encountered. The sheet normally projects to a user access area since the reversed sheet P is in contact with the outer side of the apparatus. Hence, it is necessary to restrict a length of the reversed sheet P, and thus it is also necessary to add means for preventing the reversing of the long sheet P or preventing the acquiring of the sheet P to the second tray 72 during duplex printing.

As a comparative example, in the image forming apparatus 1 having only the first tray 71, a sheet is discharged to the side of the main body. Thus, it is hard to acquire the sheet unless a direction of the body is changed. Furthermore, as the main body has a bigger size, it becomes harder to acquire the sheet. A larger installation area of the main body is also required for an area of the sheet discharge tray. Furthermore, when there is an option such as a finisher, a problem arises that the sheet discharge tray should be removed from the main body side.

In the embodiment, the third guide tray 73 is disposed below the second tray 72, that is, is disposed close to the rear side of the tray as viewed from the top and outer side, and the first tray 71 is additionally disposed outside of the second tray 72 to form the withdrawing path. Thus, it is prevented that the reversed sheet P projects to the user access area outside the apparatus. Hence, it is unnecessary to restrict a length of the reversed sheet P, and so it is possible to reverse a long sheet P. Furthermore, it is also unnecessary to add the means for preventing the acquiring of the sheets P accumulated on the second tray 72 during the duplex printing.

In the second tray 72, a problem arises that sheets are curled or attached. To solve the problem, the sheet discharge tray is disposed on the side of the reading unit in a sheet discharge direction, and thereby the sheets are able to be discharged to the top side of the image forming apparatus 1. With such a configuration, it is possible to cool down the discharged sheets while preventing temperature increase of the tray, and thus the problem can be solved.

Furthermore, it is possible to check existence of sheets even when the body direction is not changed, and thus it is possible to conveniently acquire sheets. Even when an option such as a finisher is added, by employing a sheet discharge tray in the main body, it is possible to separately acquire sheets classified as various types such as a copy, a FAX, and a print. In addition, since sheets are acquired from the top side of the apparatus, it is also possible to easily acquire sheets without paper jam even when special sheets such as a long sheet and a wide sheet are used.

In the first tray 71, by additionally disposing a sheet discharge tray on the side of the main body in the sheet discharge direction, it is possible to discharge two sheets at once. Thus, it is possible to separately discharge sheets classified as various types such as a copy, a FAX, a print, and a special sheet. It is also possible to separately discharge sheets from the top side of the apparatus when the number of the discharged sheets is small and from the side thereof when the number is large. Since the sheet discharge directions of the top side and the side thereof are same to each other, it is easy to acquire sheets.

In the embodiment, the second conveying path 52 which is a reversing path is disposed between the discharge port 18 and the discharge port 19 in the vertical direction. In addition, the discharge port 18 and the discharge port 19 are disposed apart from each other in the horizontal direction. Thereby, the long reversing path is secured. In particular, in the horizontal direction, the lower side discharge port 18 is disposed on the side of the main body 11 farther than the upper side discharge port 19 from the main body 11. Thereby, it can be prevented that the sheet P at the time of a reversing appears in the first tray 71.

### Second Embodiment

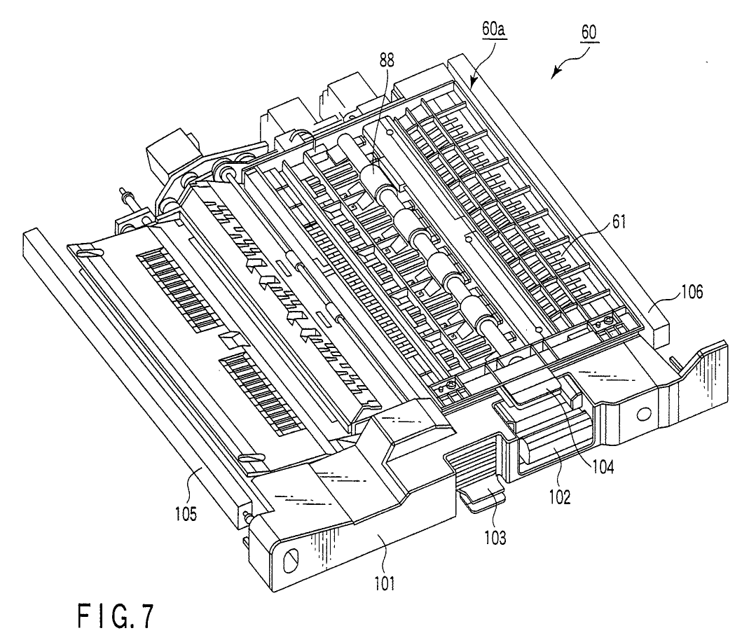

Hereinafter, an image forming apparatus 1 according to a second embodiment will be described with reference to FIGS. 7 to 9. Furthermore, the second embodiment is configured similarly to the first embodiment, and the description of the first embodiment and FIGS. 1 to 6 are applied in common to the second embodiment.

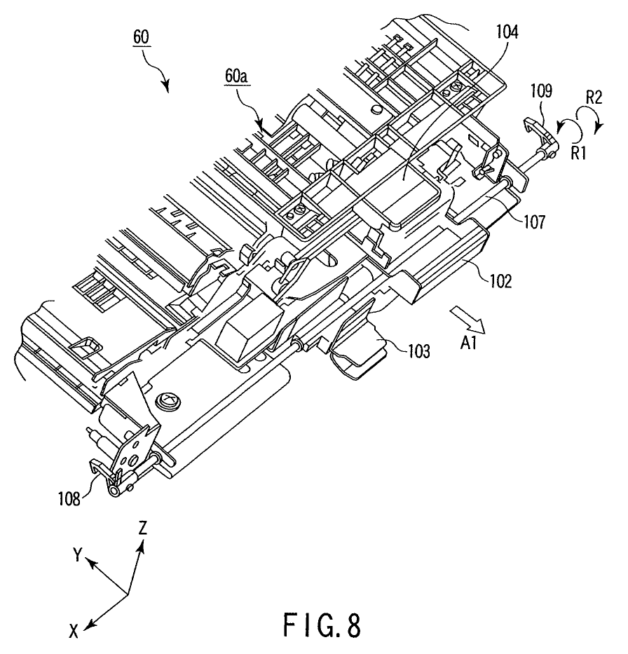

FIG. 7 is an exterior perspective view illustrating a reversing unit 60a (reversing section 60) according to the embodiment. FIG. 8 is an explanatory view illustrating a unit withdrawal operation and a holding structure at the time of acceptance of a reversing unit 60a.

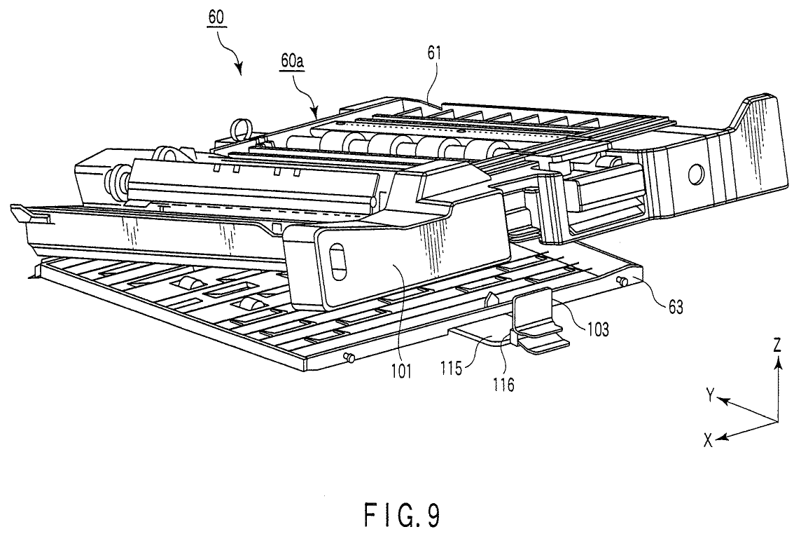

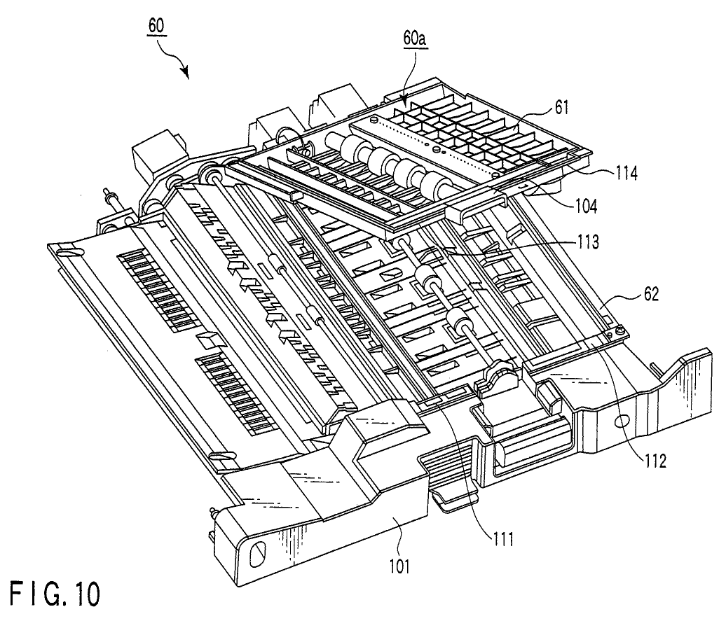

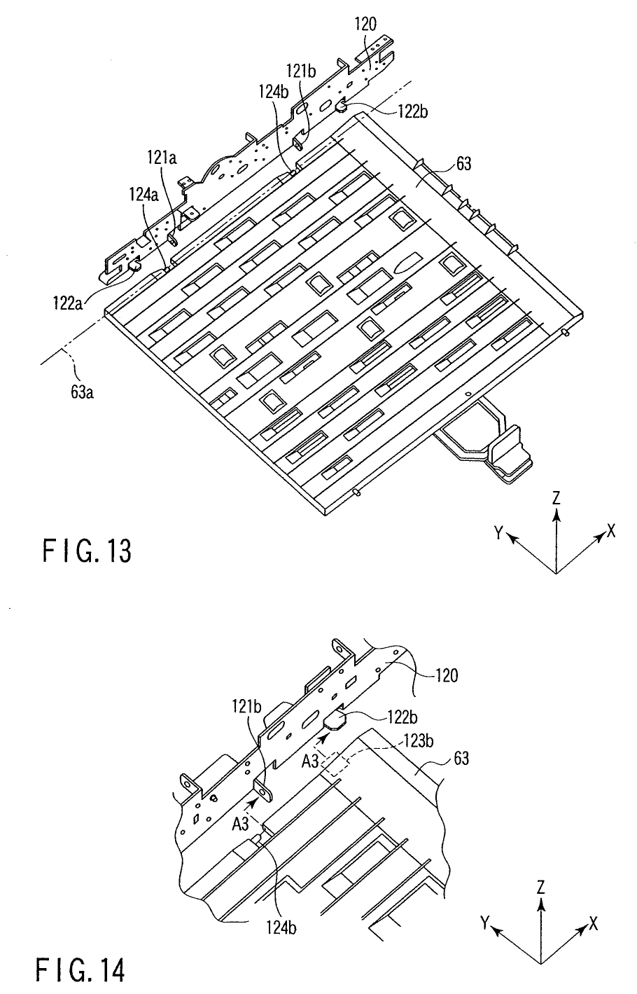

The reversing unit 60a (reversing section 60) includes an upper guide 61, an intermediate guide 62 (see FIG. 10), a lower guide 63 (see FIG. 9), a front cover 101, and a rear frame 120 (see FIG. 13). The front cover 101 is disposed in front of the intermediate guide 62. In the vicinity of the central portion of the front cover 101 of the reversing unit 60a, there are provided a withdrawal knob 102 of the reversing unit 60a, a lower guide lock lever 103, and an operation knob 104 of the upper guide 61.

The rear side edges of the first guide 61, the second guide 62, and the third guide 63 in the reversing unit 60a are attached to a rear frame 120. The first guide 61 of the upper level is operable such that the front end thereof pivots upward with respect to the second guide 62 of the intermediate level about a pivot shaft on the rear side, whereby the second conveying path 52 is opened.

Meanwhile, the third guide 63 of the lower level is operable such that the front end thereof pivots downward with respect to the second guide 62 of the intermediate level about the pivot shaft on the rear side, whereby the first conveying path 51 is opened.

An upper side conveying path (second conveying path 52) is formed between the upper side of the intermediate guide 62 and the upper guide 61. A lower side conveying path (first conveying path 51) is formed between the lower side of the intermediate guide 62 and the lower guide 63.

In the vicinity of the central portion of the front cover 101 of the reversing unit 60a, there are provided the withdrawal knob 102 of the reversing unit 60a, the lower guide lock lever 103, and the operation knob 104 of the upper guide 61.

The reversing section 60 has a pair of slide rails 105 and 106 extended from the left and right both ends in the Y direction in the drawing. The reversing unit 60a has a structure capable of being withdrawn by the pair of slide rails 105 and 106, and is housed in the main body 11 of the image forming apparatus 1. The slide rails 105 and 106 are slidably engaged with the main body 11 in a front and back direction.

Inside the front cover 101 as a front frame of the reversing section 60, there is fixed a lock shaft 107 that is extended in a left and right direction (the X direction in the drawing) and is able to pivot. On both ends of the lock shaft 107, locking hooks 108 and 109 are disposed.

To manage paper jam, it is configured that the upper and lower guides are opened in the up and down directions, respectively on the front side of the reversing unit 60a after the withdrawing operation of the reversing unit 60a.

FIGS. 9 and 10 are perspective views illustrating operations of opening the lower side conveying path and opening the upper side conveying path.

As shown in FIG. 8, the withdrawal knob 102 of the reversing unit 60a is fixed on the lock shaft 107 at the time of acceptance of the reversing unit. On the both ends of the lock shaft 107, the locking hooks 108 and 109 are disposed.

The lock shaft 107 is elastically forced by a spring (not shown in the drawing) in a rotation direction represented by an arrow R1. At the time of acceptance of the reversing unit 60a, the hook parts thereof are engaged with lock pins of the main body 11 side, and thereby the reversing unit 60a is held in the acceptance position.

Magnet catches 111 and 112 adsorptively holds metal plates 113 and 114 disposed on the upper guide 61 in a state of closing the upper guide 61. Description about a member for restricting opening amount at the time of opening the upper guide 61 is omitted.

FIG. 9 shows the state of opening the lower side conveying path (first conveying path 51).

The lower guide 63 has a pivot supporting point 124a on the rear side of the reversing unit 60a, that is, one side in the width direction. As shown in FIG. 9, the guide 63 is configured to be able to open the front side (the other side in the width direction) in the Y direction. Numeral 103 denotes a lower guide lock lever 103. The lower guide lock lever 103 is a member for opening and locking the lower guide 63. The lower guide lock lever 103 is rotatably held with respect to the plate 115. The operation of opening the lower guide 63 can be performed to release engagement by pivoting the lower guide lock lever 103 about the pivot supporting portion 116.

Descriptions are omitted for a member bearing the pivoting reaction force for holding the locking of the lower guide lock lever 103 in a state of closing the lower guide 63, and a member for restricting opening amount at the time of opening the lower guide 63.

FIG. 10 shows a state of opening the upper side conveying path. The upper guide 61 has a pivot supporting point 61a on the rear side (not shown in the drawing) of the reversing unit, and is configured to be able to open the front side thereof as shown in the drawings.

The operation knob 104 of the upper guide 61 is integrally formed with the upper guide 61 in the vicinity of the front center of the guide. By pulling upward the operation knob 104 of the upper guide 61, the upper guide 61 can be opened.

FIG. 11 is an enlarged perspective view illustrating the vicinity of an opening and closing operation portion of the reversing unit 60a. In view of operability of the operation knob 104 of the upper guide, a space for gripping the knob by user's several fingers is needed at a position just below the knob. The space is also used to operate the withdrawal knob.

In the example shown in FIG. 11, the layout is configured so that the space for withdrawal operation of the withdrawal knob 102 is also used to operate the operation knob 104 of the upper guide 61. Specifically, the space for the withdrawal knob 102 and the operation knob 104 of the upper guide 61 is selectively used as any one of a space for pulling frontward the withdrawal knob and a space for pulling upward the operation knob of the upper guide 61.

As described above, the space is shared by the two operations, and thus the layout for reducing a height of the reversing unit 60a is realized.

In the example shown in FIG. 11, a height H0 of the reversing unit 60a in the vicinity of the withdrawal knob 102 is about 80 mm. A distance H1 of a lower side operation space of the operation knob 104 of the upper guide 61 is about 20 mm. Furthermore, a distance L of a space inside the withdrawal knob 102 in the front and back direction is about 25 mm.

In the image forming apparatus 1 having the reversing unit 60a, to handle a sheet P jammed in the vicinity of the reversing unit 60a, a jam handling operation is performed in accordance with the following procedure.

Hereinafter, an opening and closing operation in the image forming apparatus 1 according to the embodiment will be described.

The withdrawing operation of the reversing unit 60a is performed as follows. The upper part of the knob 102 is pulled in the front direction represented by the arrow A1. Thereby, the lock shaft 107 is pivoted in the direction represented by the arrow R2 as shown in FIG. 8. As a result, engagement of the locking hooks 108 and 109 is released.

An operation procedure of the jam handling in the vicinity of the reversing unit 60a is performed as follows.

Act 1. Remove a sheet P which is being entered into the reversing unit 60a (remove a jammed sheet P from the fixing section 45 side).

Act 2. Remove a sheet P, which is being discharged, from the inside of the reversing unit 60a (remove a jammed sheet P from the sheet discharge tray side).

After the acts 1 and 2, the jam handling is continuously performed by withdrawing the reversing unit 60a.

The jam handling of the reversing unit 60a is performed as follows.

Act 3a. Withdraw the reversing unit 60a.

Act 3b. Open the lower side conveying path 51 and remove a jammed sheet P in the lower side conveying path 51.

Act 3c. Open the upper side conveying path 52 and remove a jammed sheet P in the upper side conveying path 52.

The withdrawing operation of the reversing unit 60a is performed by pulling frontward the withdrawal knob 102 shown in FIG. 11. By pulling the withdrawal knob 102 frontward, the lock shaft 107 is pivoted as shown in FIG. 8. Thereby, engagement of the locking hooks 108 and 109 is released and the withdrawing is enabled. Therefore, the reversing unit 60a is withdrawn by a predetermined stroke.

When the reversing unit 60a is withdrawn, it is possible to open the lower guide 63 and the upper guide 61 in the reversing unit.

The lower guide 63 is opened by operating the lower guide lock lever 103.

The upper guide 61 is opened by the operation knob 104 of the upper guide 61.

When a sheet P remaining in the vicinity of the reversing unit 60a is displayed on an operation panel (not shown in the drawing), the jam handling procedure is performed as follows.

Act 1. Remove a sheet P which is being entered into the reversing unit 60a (remove a jammed sheet P from the fixer side, in which a sheet jammed in the entrance of the circulation path 54a after the reversing is included).

Act 2. Remove a sheet P, which is being discharged, from the inside of the reversing unit 60a (remove a jammed sheet P from the sheet discharge tray side, in which a sheet P remaining in the reversing path is included).

Act 3. Remove a sheet P in the reversing unit 60a.

Meanwhile, to remove a sheet P in the reversing unit 60a, the following procedure is performed.

Act 3a. Withdraw the reversing unit 60a.

Act 3b. Open the lower side conveying path 51 and remove a jammed sheet P in the lower side conveying path 51.

Act 3c. Open the upper side conveying path 52 and remove a jammed sheet P in the upper side conveying path 52.

As a practical operation, the reversing unit is withdrawn by pulling the withdrawal knob 102 frontward. Subsequently, the upper guide 61 is opened by pulling upward the operation knob 104 of the upper guide 61.

In the image forming apparatus 1 according to the embodiments configured as described above, two spaces are shared by three operations of the withdrawal knob, the operation knob of the upper guide, and the lower guide lock lever. With such a configuration, it is possible to reasonably secure the space for the jam handling of the reversing unit 60a configured so that the space is saved in the vertical direction. According to the image forming apparatus 1 of the embodiment, the following advantages are obtained. Consequently, since the layout sharing the operational space is designed, it is not necessary to secure a new operational space in order to perform the opening operation of the upper guide. As a result, it is possible to save space in the apparatus and achieve excellent jam handling operability.

### Third Embodiment

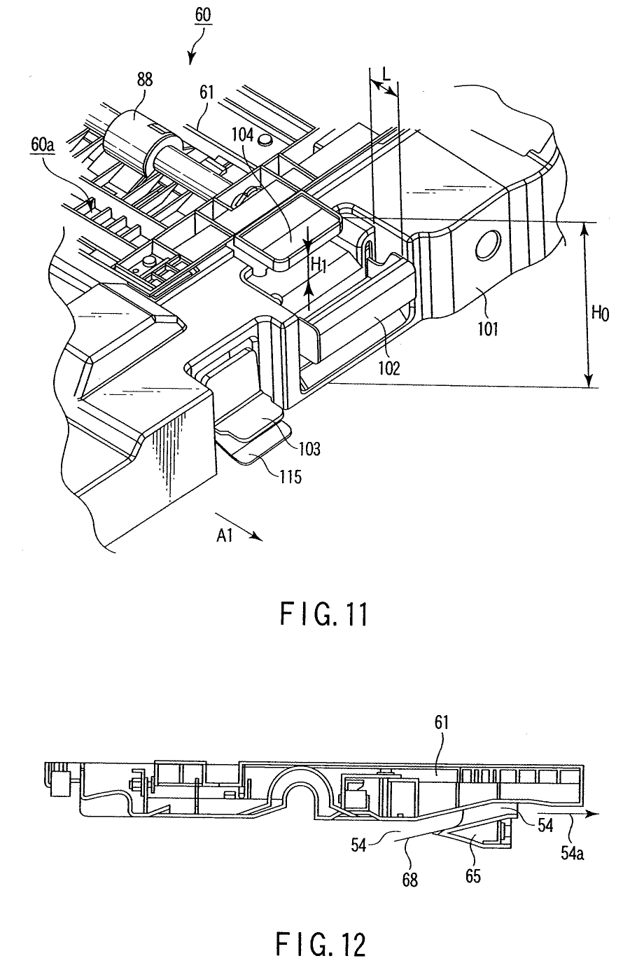

Hereinafter, an image forming apparatus 1 according to a third embodiment will be described with reference to FIG. 12. Furthermore, the third embodiment is configured similarly to the first embodiment, and the description of the first and second embodiments and FIGS. 1 to 11 are applied in common to the third embodiment.

In the embodiment, it is further described that an upper guide 61 of a second conveying path 52 holds a fifth guide 65, as compared with the image forming apparatus 1 according to the first and second embodiments.

In the reversing unit 60a shown in FIG. 2, a path to a first tray 71 is formed on the lower side of a first gate 66. In addition, a path to a second tray 72 is formed on the upper side of the first gate 66.

Furthermore, on the upper side of the first gate 66, a reverse gate holding member 65 (fifth guide 65) is disposed. A lower side surface of the reverse gate holding member 65 constitutes the path to the second tray 72. An upper side surface of the reverse gate holding member 65 constitutes an entry portion to a circulation path 54a and a fourth conveying path.

FIG. 12 is a schematic view for explaining the upper guide 61. On the upper guide 61, the reverse gate holding member 65 is fixed. The reverse gate 68 (reverse film 68) is held by being attached to the reverse gate holding member 65.

Furthermore, it is not necessary that the reverse gate holding member 65 is completely fixed to the upper guide 61, and the reverse gate holding member 65 may be held at a predetermined position in a state where the upper guide 61 is closed with respect to the intermediate guide 62.

As an example, when the reverse gate 68 is made of a flexible sheet member, a sheet member and a sheet holding member are provided.

The case where a sheet P (recording medium) is guided into the circulating path 54a is similar to the first process of the first embodiment. In this case, the sheet P entered from a unit entrance 60b is conveyed from the first gate 66 to the second conveying path 52 through the lower part of the reverse gate 68. Then, the sheet is temporally stopped and is reversely conveyed by a reversing roller 88. Subsequently, the sheet is guided upward to a fourth conveying path 54 by the reverse gate 68. Then, the sheet is sent toward a unit exit 60c which is an entry for entering to the circulating path (circular conveying path) 54a.

In the schematic view of FIG. 12, the holding member 65 having a triangular shape extends in a direction orthogonal to the sheet conveying direction. Both ends of the holding member are attached to the upper guide 61. Specifically, the holding member 65 is formed in a tunnel shape forming an aperture through which the sheet P is able to pass.

As described with reference to FIG. 12, the reverse gate 68 is held by the upper guide 61, and thereby there is a merit at the time of the jam handling. Since the above-mentioned structure is employed, jam handling operability is kept with respect to all three conveying paths.

Specifically, when the upper guide 61 is opened as shown in FIG. 2, the reverse gate 68 and the reverse gate holding member 65 are opened upward at the same time. Thus, the periphery of the first gate 66 is accessible, and so it is easy to handle jamming in the vicinity of the first gate 66. Specifically, in consideration of jam handling operability, it is configured that the reverse gate 68 is opened together with the upper guide 61 when the upper guide 61 is opened. Hence, when the upper guide 61 of the second conveying path 52 is opened by being pivoted about the rear side supporting point 61a of the unit as a pivot supporting point, the reverse gate 68 and the reverse gate holding member 65 do not disturbs the opening of the second conveying path 52.

### Fourth Embodiment

Hereinafter, an image forming apparatus 1 according to a fourth embodiment will be described with reference to FIGS. 13 to 15. Furthermore, the fourth embodiment is configured similarly to the first to third embodiments, and the description of the first to third embodiments and FIGS. 1 to 12 are applied in common to the fourth embodiment.

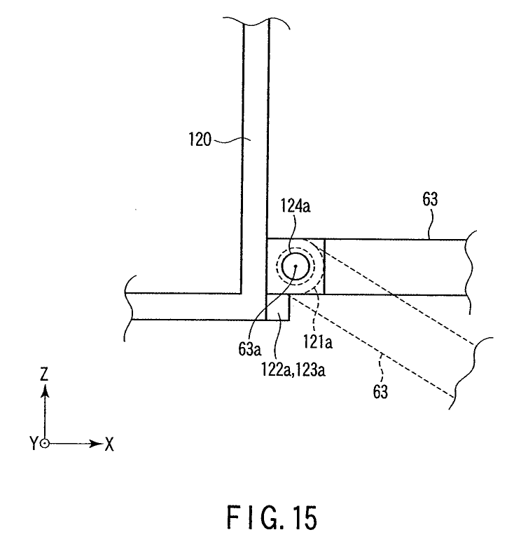

FIG. 13 is an explanatory view illustrating a lower guide according to the embodiment. FIG. 14 is an enlarged perspective view illustrating a part of the lower guide and the rear plate shown in FIG. 13. FIG. 15 is a side view illustrating the lower guide and the rear plate.

The rear side edges of a first guide 61, a second guide 62, and a third guide 63 in a reversing unit 60a are attached to a rear frame 120. The first guide 61 of the upper level is operable such that the front end thereof pivots upward with respect to the second guide 62 of the intermediate level about a pivot shaft on the rear side, whereby a second conveying path 52 is opened.

Meanwhile, the third guide 63 of the lower level is operable such that the front end thereof pivots downward with respect to the second guide 62 of the intermediate level about the pivot shaft on the rear side, whereby a first conveying path 51 is opened.

Pivot supporting shafts 124a and 124b are held at two locations in the same axial line with respect to the lower guide 63 of the conveying section 16 conveying a recording medium substantially in the horizontal direction.

The supporting shaft 124a and 124b of the lower guide 63 are held rotatably by supporting-point holding portions 121a and 121b of the rear frame 120 of the reversing unit 60a.

Numerals 122a and 122b are end position regulating members on the supporting point side. In this case, the end position regulating members 122a and 122b are formed in a cut metal plate shape as parts of the rear frame 120.

In a close state of the lower guide 63, the lower guide 63 is held to be able to open to the lower side at a position, at which the pivoting operation of the lower guide 63 is not disturbed, in the vicinity of the axial line of an area outside (end portion side in the X direction) of an area interposed between two pivot supporting portions. In this state, a holding surface for preventing slip-down of the end portion of the lower guide is required. Thus, the holding surface is formed close to the supporting point on the guide. Thereby, in the close state, the guide is held such that the holding surface comes in contact with the end position regulating member on the supporting point side.

To assemble the lower guide 63 into the rear frame 120, the supporting shaft 124b is inserted into the supporting-point holding portion 121b in a direction represented by the arrow A3 (at this time, the supporting shaft 124a is also inserted).

As the result of the assembly, the holding surface 123b of the lower guide 63 on the supporting point side is located just above the end position regulating member 122b.

By assembling the lower guide 63 into the rear frame 120, it is possible to exactly locate and hold the holding surface 123b on the supporting point side at a just designed position in a state where the lower guide 63 is horizontally held (the close state changed from the open state).

According to the embodiment, when the lower guide 63 made of resin has a large size and when relatively high temperature is required as a usage condition, it has a great advantage that a conveying surface of the lower guide 63 can be maintained at a precise position. In addition, when relatively high temperature is required as a usage condition, to maintain the conveying surface of the lower guide at a precise position, it is possible to prevent droop of the end portions of the lower guide 63 on the supporting point side.

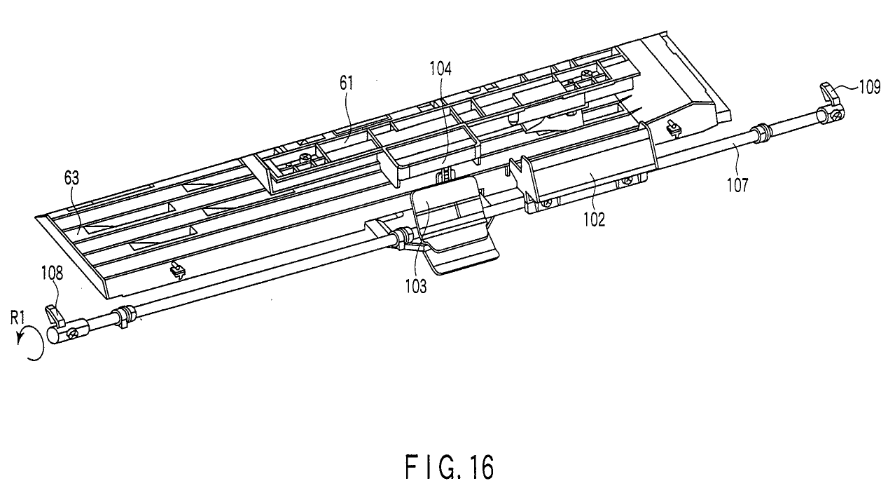

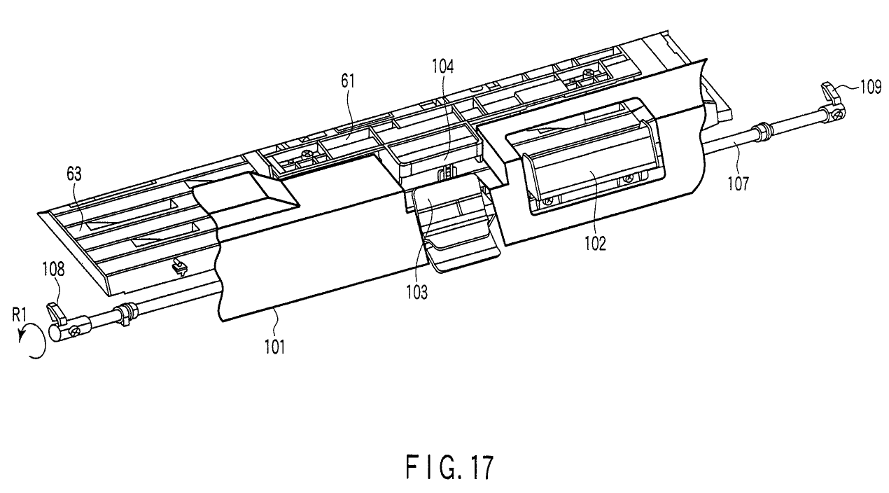

Furthermore, the invention is not limited to the embodiments. For example, in the second embodiment, the operational space of the withdrawal knob 102 and the operational space of the operation knob 104 of the upper guide 61 are common to each other. However, as shown in FIGS. 16 and 17, the operational space of the lower guide lock lever 103 and the operational space of the operation knob 104 of the upper guide 61 may be common to each other. FIGS. 16 and 17 show states where the front cover 101 is removed and the front cover 101 is disposed when the operational space of the lower guide lock lever 103 and the operational space of the operation knob 104 of the upper guide 61 are common to each other.

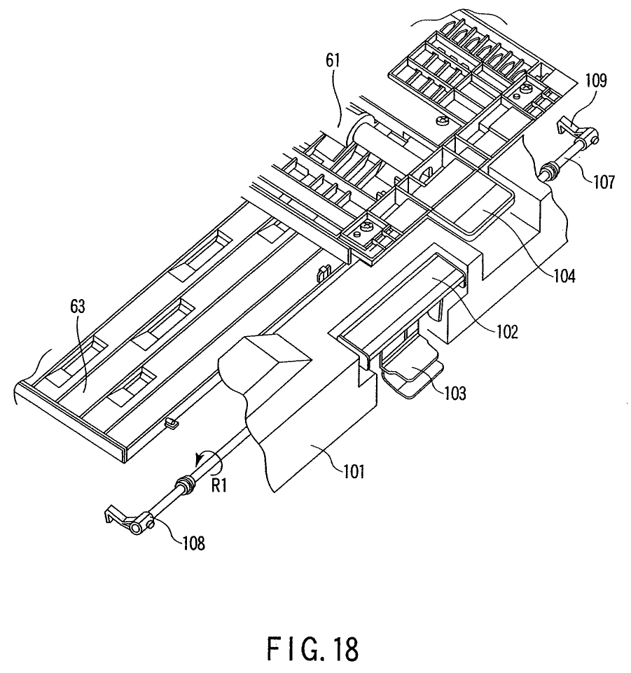

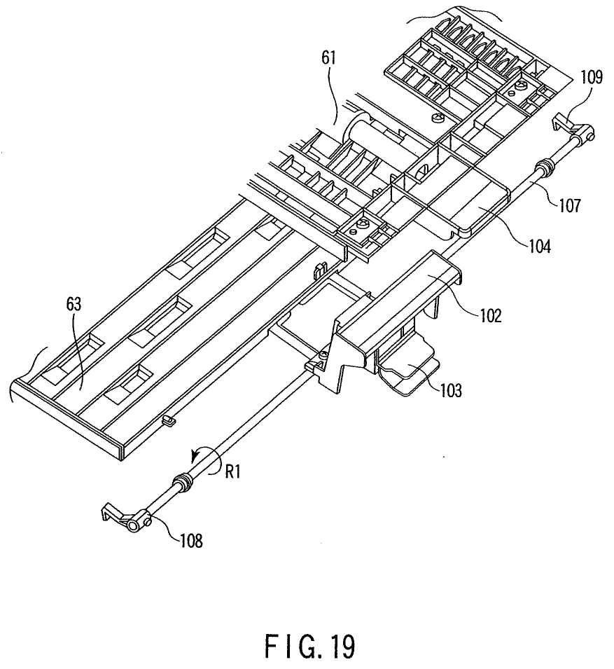

Furthermore, as shown in FIGS. 18 and 19, it is possible to share one space for the operation of the withdrawal knob 102 and the operation of the lower guide lock lever 103. FIGS. 18 and 19 show an exemplary case where the operational space of the withdrawal knob 102 and the operational space of the lower guide lock lever 103 are common to each other. FIG. 18 is a view illustrating the state where the front cover 101 is mounted, and FIG. 19 is a view illustrating the inside of the front cover 101.

Furthermore, the reverse gate (reverse film) 68 is formed as a flexible sheet member, but is not limited to the sheet member. Specifically, it is possible to employ a gate structure that is able to pivot and has a position capable of being stabilized by a weight of itself.

The invention may be realized by modifying components in various forms without departing from the technical spirit of the invention. Furthermore, the technical spirit of the invention involves various forms obtained by appropriate combination among components disclosed in the embodiments. For example, several components may be removed from the whole components disclosed in the embodiments. In addition, the components disclosed in the different embodiments may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the invention as defined by the appended Claims and equivalents thereof.

What is claimed is:

1. An image forming apparatus comprising:
an image forming section which forms an image on a sheet-like recording medium;
a conveying path through which the recording medium passes;
a conveying section which conveys the recording medium along the conveying path in a conveying direction and has a reverse conveying portion which reversely conveys the recording medium in a direction opposite to the conveying direction on the conveying path;
a main body which houses the image forming section;
a first medium holding section which is disposed on the main body to hold the recording medium discharged from a first discharge port;
a second medium holding section which holds the recording medium discharged from a second discharge port disposed above the first discharge port of the main body; and
a third medium holding section which is disposed below the second medium holding section to hold the recording medium reversely conveyed by the conveying section.

2. The apparatus according to claim 1, further comprising:
a circulation path which is disposed on the conveying path to reverse the front and back sides of the recording medium,
wherein the first and second discharge ports are disposed on an exterior part of the main body, and
wherein the third medium holding section holds the recording medium reversely conveyed to the circulation path.

3. The apparatus according to claim 1, wherein the conveying path has
a first conveying path which reaches the first discharge port from the image forming section,
a second conveying path which reaches the second discharge port disposed above the first discharge port by branching upward from a first branch portion disposed on the first conveying path and has a reverse conveying portion reversely conveying the recording medium in the course thereof,
a third conveying path which branches downward from a second branch portion disposed on the second conveying path and into which the recording medium reversely conveyed by the reverse conveying portion withdraw, and
a fourth conveying path conveying the recording medium reversely conveyed by the reverse conveying portion to a sheet discharge circulation path.

4. The apparatus according to claim 1,
wherein the first medium holding section is disposed outside of the second medium holding section, and
wherein an outer leading end of the second medium holding section is disposed outside of an outer leading end of the third medium holding section.

5. The apparatus according to claim 1, wherein the conveying section has
a guide disposed along the conveying path to guide the recording medium,
a roller disposed along the conveying path to convey the recording medium, and
gates disposed on the branch portions, respectively, to open and close the conveying path.

6. The apparatus according to claim 1, further comprising a control section which allows the recording medium from the image forming section to be subjected to any one of
a first process of reversely conveying the recording medium through the second conveying path and the third conveying path, and reconveying the recording medium to the image forming section through the fourth conveying path,
a second process of discharging the recording medium from the second discharge port through the second conveying path, and
a third process of discharging the recording medium from the first discharge port through the first conveying path.

7. The apparatus according to claim 1, wherein a reversing unit constituting the conveying path has
an intermediate guide disposed on a lower side of the second conveying path and on an upper side of the second conveying path,
an upper guide disposed above the second conveying path to open the second conveying path by pivoting upward with respect to the intermediate guide about a supporting point on one side in a width direction orthogonal to the conveying direction, and
a lower guide disposed on a lower side of the first conveying path to open the first conveying path by pivoting downward with respect to the intermediate guide about the supporting point on the one side.

8. The apparatus according to claim 7, wherein the reversing unit is housed in the main body to be slidable in the width direction and the upper guide and the lower guide are pivotable with respect to the intermediate guide in a state of being withdrawn from the main body by sliding toward the other side in the width direction.

9. The apparatus according to claim 7, wherein an operational space for pivoting of the lower guide is common to an operational space for pivoting of the upper guide.

10. The apparatus according to claim 8, wherein an operational space for pivoting of the upper guide is common to an operational space for withdrawing the reversing unit from the main body.

11. The apparatus according to claim 8, wherein an operational space for pivoting of the lower guide is common to an operational space for withdrawing the reversing unit from the main body.

12. The apparatus according to claim 3, further comprising a fourth guide which constitutes the second branch portion and divides the second conveying path and the third conveying path.

13. The apparatus according to claim 7, further comprising a fifth guide which is disposed between the upper guide and the lower guide, constitutes a third branch portion branching to the fourth conveying path on an upstream side from the reverse conveying portion of the second conveying path, and divides the second conveying path and the fourth conveying path.

14. The apparatus according to claim 13,
wherein the fifth guide is fixed on the upper guide with a space capable of passing the recording medium interposed therebetween and pivots together with the upper guide when the upper guide pivots upward, and
wherein a third switch gate is disposed on the third branch portion of the fifth guide.

15. The apparatus according to claim 7, wherein a supporting tool supporting the lower guide is formed below a pivot shaft as a supporting point for pivoting the lower guide, and is formed on a position different from the pivot shaft in the conveying direction.

16. The apparatus according to claim 7, wherein a supporting tool supporting the lower guide from below is formed on the one side in the width direction, below a pivot shaft as a supporting point for pivoting the lower guide.

17. The apparatus according to claim 3, wherein a distance from the first branch portion to a downstream side end of the third conveying path is larger than a size of the recording medium in the conveying direction.

18. The apparatus according to claim 3, wherein the third medium holding section is formed on the rear side of the second medium holding section.

19. The apparatus according to claim 6, wherein the conveying section performs the third process on another recording medium when the recording medium is being withdrawn to the third conveying path in the first process.

20. A method for forming an image comprising:
outputting an image on a sheet-like recording medium;
conveying the recording medium having the image formed thereon along a predetermined conveying path having
a first conveying path which reaches the first discharge port from the image forming section,
a second conveying path which reaches the second discharge port disposed above the first discharge port by branching upward from a first branch portion disposed on the first conveying path and has a reverse conveying portion reversely conveying the recording medium in the course thereof,
a third conveying path which branches downward from a second branch portion disposed on the second conveying path, and
a fourth conveying path which reaches the image forming section from the reverse conveying portion; and
withdrawing the recording medium to be reversely conveyed by the reverse conveying portion into the third conveying path after conveying the recording medium to the second conveying path.

21. The method according to claim 20, wherein the recording medium is conveyed from the image forming section by performing any one of
a first process of reversely conveying the recording medium through the second conveying path and the third conveying path, and reconveying the recording medium to the image forming section through the fourth conveying path,
a second process of discharging the recording medium from the second discharge port through the second conveying path, and
a third process of discharging the recording medium from the first discharge port through the first conveying path.

22. The method according to claim 20, wherein the third process is performed on another recording medium when the recording medium is being withdrawn to the third conveying path in the first process.
